(19) United States
(12) Patent Application Publication
(10) Pub. No.: US 2007/0238593 A1
(43) Pub. Date: Oct. 11, 2007

(54) Method for increasing fitness level while losing body weight

(76) Inventors: Mary Dorothy Ellis, Pensacola, FL (US); Marion Edmond Ellis, Pensacola, FL (US)

Correspondence Address: Mr. Marion E. Ellis, 1160 Peperidge Drive, Pensacola, FL, 32504, US

(21) Appl. No.: 11/732,986

(22) Filed: Apr. 5, 2007

Related U.S. Application Data
(60) Provisional application No. 60/790,061, filed on Apr. 7, 2006.

(51) Int. Cl. G06Q 10/00; A63B 23/00

(52) U.S. Cl. 482/148; 705/2

(57) ABSTRACT

A method of six (6) weeks duration for increasing body fitness level while reducing health risks, reducing inches of girth for body parts and losing body weight is provided. The method is comprised of three steps: (1) Body Cleansing, (2) Muscle Toning and Strengthening, and (3) Body Balancing. Each step is of two weeks duration and is comprised of a specific eating plan (in the case of step 1 includes a water intake regimen) and a specific exercise plan. The eating plan and exercise plan of each step is specifically formulated to provide upon completion of the six (6) weeks significant weight loss, lower BMI and reduced body part girth.

### CROSS-REFERENCE TO RELATED APPLICATION

The application claims the benefit of U.S. Provisional Patent Application Ser. No. 60/790,061 filed Apr. 7, 2006.

### FIELD OF THE INVENTION

The present invention generally relates to physical fitness and the loss of excess body fat and the accompanying lowering of the body mass index or BMI. BMI is a measure which takes into account a person's weight and height to gauge total body fat in adults. BMI is one of the most accurate ways to determine when extra pounds translate into health risks and is accepted by the US government, who In June 1998, announced guidelines which create a new definition of a healthy weight, a BMI of 24 or less. The higher the BMI, the greater the risk of developing additional health problems.

More particularly, this invention teaches a method composed of three 2-week periods which result in significant weight loss, reduced BMI and reductions in the measurements of exercisers for the bust (women), waist, abdomen, hips, thighs, calves, and arms. The method is effective for both beginning exercisers and seasoned exercisers who have “plateaued”.

The first 2-week period is designed for body cleansing by “jump starting” catabolism or destructive metabolism; which is the process that produces the energy required for all activity in the cells. In destructive metabolism, cells break down large molecules (mostly carbohydrates and fats) to release energy. As complex chemical units are broken down into more simple substances, the waste products released in the process of catabolism are removed (cleansed) from the body through the skin, kidneys, lungs, and intestines and is accomplished by utilizing an eating plan, water intake plan and an exercise plan.

The second 2-week period is designed to increase anabolism or constructive metabolism. Anabolism supports the growth of new cells, the maintenance of body tissues, and the storage of energy for use in the future and is necessary for muscle toning & strengthening. The increased anabolism is accomplished with a second eating plan and a second exercise plan.

The third 2-week period is designed to maintain the body to its new improved or enhanced level and introduces a third eating plan and a third exercise plan to bring catabolism and anabolism into balance.

### BACKGROUND OF THE INVENTION

Relative to weight loss and physical fitness the teachings of the prior art can be grouped into two basic categories; (1) the diet oriented and (2) the exercise oriented.

Prior art representative of the diet oriented category is found in the teachings of Dr. Sandra Cabot, “The Body Shaping Diet”, SCB International, 2000.

Prior art representative of the exercise oriented category is found in the teachings of Jackowski, U.S. Pat. No. 6,945,911, Jackowski, Sep. 20, 2005.

Interestingly both categories draw heavily upon the work of Dr. William H. Sheldon's, “The varieties of human physique: An introduction to constitutional psychology” (New York: Harper & Brothers, 1940) relative to the concept of body types and their shapes and list body type or shape as a major component of their method of weight loss; diet or exercise.

In the 1940s, Sheldon assigned people into three categories of body types; endomorphic, mesomorphic, and ectomorphic. Endomorphics had fat, soft, and round body types; Mesomorphics were muscular, rectangular, strong and Ectomorphics were thin, long, fragile. Since that time medical science has provided us with a greater understanding of the hormonal and metabolic differences between the body types and new names have been coined along with the defining of at least one additional type.

Cabot provides us with the names of: Android, Thyroid, Lymphatic and Gynaeoid (see www.weightcontroldoctor.com). Relative to Sheldon's classification, Android is the mesomorph, Thyroid is the ectomorph, and Lymphatic is the endomorph. Gynaeoid, was not described by Sheldon and is being considered now as a combination of several types. Jackowski provides us with still other names for four body types: Hourglass, Spoon, Ruler and Cone; stating that they are simply a classification of a person's physique into a category that corresponds to where that person's body tends to be bulkiest and tends to gain fat and muscle.

As a proponent of diet oriented weight loss and physical fitness; Cabot stresses body shape and diet as the most important to weight loss and physical fitness while hormonal balance is somewhat significant. Minimal importance is afforded to exercise in achieving fitness goals.

As a proponent of exercise; Jackowski stresses exercise and body shape in achieving fitness goals with no regard for diet.

Neither Cabot's or Jackowski's teachings provide for objective results within a short period of time.

What is needed is a balanced fitness method which provides for the “jump starting” of body metabolism from an anabolic state to a catabolic or fat burning state; restores the anabolic/catabolic balance and is designed to work in concert with specific exercise regimens to achieve, in a short span of time, quantifiable fitness results in pounds, inches, and indices; regardless of body type.

### SUMMARY OF THE INVENTION

It is an object of this invention to provide a six (6) week method which utilizes eating plans, water intake, and exercise regimens specific to each of three 2-week periods of time to rapidly move the body metabolism of exercisers from the anabolic to a fat burning catabolic state and then restore the anabolic/catabolic balance of metabolism such that significant weight loss in pounds is achieved accompanied by reductions in the measurements for the bust (women), waist, abdomen, hips, thighs, calves, and arms and improved fitness evidenced by lower BMI.

It is another object of this invention to formulate an eating plan and water intake regimen for the first 2-week period to cleanse the individual exerciser's body and “jump start” his or her metabolism from anabolic to the catabolic fat burning state.

It is another object of this invention to provide an exercise regimen over and above that of each exerciser's ongoing regimen, if any, to be utilized in concert with the eating plan and water intake regimen designed for the first 2-week body cleansing period.

It is the further object of this invention to provide an eating plan and exercise regimen following cleansing to provide for muscle strengthening and muscle toning while losing weight and inches of girth around the waist and limbs.

It is still the further object of this invention to provide an eating plan and exercise regimen designed for metabolic balance and the maintenance of the individual exerciser's body to the new improved or enhanced level at the end of the six (6) week process as evidenced by reductions in inches of girth around the abdomen, waist and limbs as well reductions in body weight and BMI.

According to the present invention; there is provided an eating plan and water intake regimen to be followed for the first 14 days of the method to cleanse the body and “jump start” the body metabolism from anabolic to catabolic.

Examples of the daily menus to be followed for the first 14 days of the process of the current invention are shown below in Tables I and II:

TABLE I

| | |
|---|---|
| Breakfast | 6 oz. veggie juice, veggie omelet, decaff |
| | coffee/tea (w/non-fat milk, sugar substitute) |
| Snack | One half mozzarella cheese stick |
| Lunch | Grilled chicken or turkey breast, romaine lettuce, |
| | Sugar-free gelatin |
| Snack | Celery stick. One half cheese stick |
| Supper | Grilled fish, tossed salad (mixed greens, peppers, |
| | cherry tomatoes, low cal vinegar and oil dressing) |
| Snack | Celery stick, one half cheese stick |

TABLE II

| | |
|---|---|
| Breakfast | 6 oz. tomato juice, one half cup Egg Beaters, 2 |
| | slices Canadian bacon, decaff coffee/tea |
| | (w/non-fat milk, sugar substitute) |
| Snack | Lettuce sandwich using chicken or turkey slice, |
| | romaine lettuce, two tbsp of low cal mayonnaise |
| Lunch | Tuna salad made with 1 can tuna packed in water, |
| | one half tomato, one half cucumber, small piece |
| | celery, 1 cup dressing made using fresh garlic, |
| | lemon juice, virgin olive oil, pepper |
| Snack | Celery stick. One half cheese stick |
| Supper | Baked chicken breast, assorted roasted veggies, |
| | Small green salad, dessert of non-fat yogurt |
| Snack | One half mozzarella cheese stick |

The water intake regimen for the first two (2) weeks of the process of the current invention is comprised of the drinking one (1) ten ounce glass of water an hour during the awake hours which is essential to the cleansing process.

According to the present invention; there is provided an exercise regimen to be followed for the first 14 days of the method to cleanse the body and “jump start” the body metabolism from anabolic to catabolic. The exercise regimen is performed for one hour each of three days each week, preferably Monday, Wednesday and Friday of each week.

The exercise regimen the first week or 7 days is as follows:
Week 1—Monday-Legs on 4 Inch Bench,
1. Warm up and stretch
2. Starting on top of bench 3 sets of 10 lunge tap downs right foot to back of bench off of bench
3. Starting on top of bench 3 sets of 10 lunge tap downs right foot to side of bench off of bench
4. 3 sets of 10 combinations of tapping foot back and side of bench
5. Repeat 2 times
6. Repeat 2 through 5 on left foot and left side of bench
7. Starting on floor 3 sets of 10 alternating lunges right and left onto bench
8. Starting on top of bench 3 sets of 10 back lunges on right foot
9. Starting on top of bench 3 sets of 10 back pulse lunges on right Repeat 7, 8, 9 on left
10. Starting on floor 3 sets of 10 right and left alternating front lunges onto bench
11. Starting on floor 3 sets of 10 front lunges on right foot
12. Starting on floor 3 sets of 10 pulse lunges on right
13. Repeat 11 and 12 on left
Abductors, Outer Thigh.
1. Standing with feet hip distance apart pelvic tucked under and knees slightly bent lift from the hip the right leg then the left leg, thigh lifts, 3 sets of 10 alternating
2. Standing on left leg lift opposite hip lift right leg past opposite knee to the side of the body and lower for 3 sets of 10 times
3. Standing on left leg lift right hip then lift right leg past opposite knee hold the leg there and pulse up for 3 sets of 10 times
4. Repeat 2 and 3 on left leg
5. Squats, standing with feet more than hip distance apart all of the weight of the body on yours heels lower your rear end as if to set in a chair and then lift it keeping your shoulders square. Toes pointing to the front do 3 sets of 10
6. Squat Pulse, standing with feet more than hip distance apart all your weight on the heels set your rear down keeping your shoulders square hold there and pulse down with rear end for 3 sets of 10 times
7. Standing ham string curls, standing with feet hip distance apart knees bent pick up right heel as if to kick yourself in the rear, make sure your pelvic is tilted under and do this 3 sets of 10 times
8. Standing hamstring pulse, standing with feet hip distance apart knees bent pelvic tucked under pick up your right heel and pull it to your rear end and hold there bring your heel into your rear as if to kick your self very small lifts for 3 sets of 10
9. Repeat 7 and 8 on left side
Abductors, Inner Thigh
1. Inner Thigh Squats, standing with feet more than hip distance apart, toes pointed out, pelvic tucked under and abs pulled in tightly, drop your rear end down as low as you can, as you lift your rear squeeze your inner thighs together, 3 sets of 10 times
2. Inner Thigh Squats Pulses, standing with feet more than hip distance apart toes pointed out, pelvic tucked under and abs pulled tightly in drop your rear end as low as you can, stay there and squeeze your thighs together in small pulses for 3 sets of 10 times
3. Cool down and stretch
4. Homework —50 regular sit-ups. 50 oblique crunches Right and left side, 50 reverse curls for lower abs, 50 full sit-ups, bicycle burn out for 3 minutes
Wednesday—Week 1-Upper Body and Arms
Note: 3 to 5 pounds weights used for these exercises. Exercises will be done while standing, leg hip distance apart and pelvic always tucked under and abs in tightly
1. Reverse curl using 3 to 5 pound dumbbells, 3 sets of 10 times
2. Upright Row using 3 to 5 pounds dumbbells, 3 sets of 10 times
3. Military Press using 3 to 5 pounds dumbbells, 3 set of 10 times
4. Bicep curl alternate right and left using dumbbell 3 to 5 pounds 3 sets of 10 times
5. Bicep curl on right only using 3 to 5 pounds 3 sets of 10
6. Bicep curl on left hand using 3 to 5 pounds dumbbells, 3 sets of 10
7. Hammer curl alternate right and left 3 to 5 pounds dumbbells 3 sets of 10
8. Hammer curl on right 3 to 5 pounds 3 sets of 10
9. Hammer curl on left 3 to 5 pounds 3 sets of 10
10. Dumbbell lateral raises alternate on right and left using 3 pounds 3 sets of 10
11. Dumbbell lateral raises on right only 3 sets of 10, 3 pounds
12. Dumbbell lateral raises on left 3 set of 10 3 pounds
13. Dumbbell lateral raises for front alternate right and left 3 sets of 10 using 3 pounds
14. Dumbbell lateral raises to front on right 3 sets of 10 using 3 pounds
15. Dumbbell lateral raises to front on left side 3 sets of 10 using 3 pounds
16. Triceps kickbacks alternating right and left using 5 pounds dumbbell 3 sets of 10
17. Triceps kickbacks on right 3 sets Of 10 using 5 pound dumbbell
18. Triceps kickbacks on left 3 sets of 10 using 5 pounds dumbbell
19. Chest, Flat Dumbbell Fly 3 sets of 10
20. Push-up, 2 sets of 10
21. Homework, Abs Knee-ins 3 sets of 15, reverse curl to burn out, double leg raises to burn out
Friday Week-1-Combination of Upper and Low and Boot Camp Cardio
Warm-up and Stretch, Basic step work-out on bench with 2 risers
Performing knee's, hamstring curls, kicks, outer thigh lifts, inner thigh lifts, lunges, squats off of the bench. 3 sets of 10 alternating, 3 sets of 3 repeaters on each leg of each item named above.
1. On the floor using 3 to 5 pound dumbbells in each hand
2. Hustle us 1-2-3 lateral up to front from side, 5 lbs.
3. Hustle back 1-2-3 lateral pull down to side, 5 lb
4. hustle up 1-2-3 both arm right and left lift to shoulders, 5 lbs. in each hand, then bring down
5. Perform 2 and 3 for 3 sets of 10
6. perform 4, 3 sets of 10
7. Grapevine right 1-2-3 lateral lift from side up to right shoulder 5 lbs.
8. Grapevine left 1-2-3 lateral lift from the left side up to the right shoulder, 5 lbs. then bring down
9. Grapevine right 1-2-3 lateral lift to the sides both right and left hand lift to shoulders holding each 5 lbs weights and bring them down
10. Perform 7 and 8 for 3 sets of 10
11. Perform 8 for 3 sets of 10
12. Squats with bicep curls, start in a squat position the down position, 5 lb. dumbbells in each hand elbows into to waist palms facing front as you lift your squat do a bicep curl, do 3 sets of 10 of bicep curls
13. Stationary lunge, in a lunge position 5 lbs dumbbells in each hand elbows into waist, arms at shoulders, palms facing each other, as you lunge your back knee down toward the floor, kick back both arm into triceps kick back, do 3 sets of 10
14. Stationary lunge pulse, in a lunge position using 5 lbs. dumbbells in each hand, elbows close to your side, arms in the triceps kick back position, start pulsing your right knee down toward the floor, make sure your pelvic is tilted under and abs are tightly squeezing in after a few repetitions start your triceps kickback pulses. Do 3 sets of 10
15. Repeat the very exact exercise with the left knee pulsing toward the floor. Do 3 sets of 10
16. Hammer curl, upright Row and squat combination, Start standing with feet more than hip distance apart pelvic tilt and abs tight. Using 5 lb dumbbell in each hand. Palms facing each other and in front of your body, curl weights to shoulders, curl them down in front of body, turn palms to face your thighs, do a squat, as you come from the squat do an upright then bring arms back in front of body, do 3 sets of 20
17. Squats with Abduction lift, Bring the body down into a squat position, as you come up from the squat lift from the hip your right leg out in a side leg lift as you bring your leg down go back into your squat.
18. Repeat 17 on the left leg for 3 sets of 10
19. Home work, 50 full sit-ups, 50 reverse curls, 50 waist bends both right and left, 50 push-ups, bicycle to burn out.

The exercise regimen the second week or 7 days is as follows:
Week-2—Monday-Exercises are exactly the same as Monday of Week I with the exception of repetitions, height of bench, and size of weights.
1. Put one riser under the bench whenever you use it.
2. Do 3 set of 12 repetitions and use dumbbells from 5 to 8 pounds whenever you use the dumbbell.
3. Homework same as Week 1
Week-2—Wednesday-Exercises are the same as Week 1—Wednesday with the exceptions of repetitions are 3 sets of 12 and the weights increase to 5 to 8 pounds. When a bench is used, add one riser. Add one short cardio circuit routine between sets as follows:
1. 1-2 minutes of frog jumps
2. 5 second rest
3. 1 minute of Jumping Jacks
4. 5 second rest
5. 1 minute mountain climbers
6. Homework—Using your large exercise ball, holding the ball between your heels and ankles, do 25 reverse curls, 25 full sit-ups holding the ball in your hands, 25 jack knifes sit-ups, lying on back legs straight, arm straight overhead on floor behind you ball in your hand bring the ball over your shoulders stop there and bring your feet to the ball get the ball with your feet, then leaving your feet there bring your hands down. Do again starting your feet up first. Do 25 times
Week-2—Friday-Exercises are the same as Week 1-Friday exceptions are weight is now 5 to 8 pounds, repetitions are 3 sets of 12; when bench is used add one riser under it. Circuit added:
1. 1 Jumping Jack, 1 push-up
2. 2 jumping jacks, 2 push-up
3. 3 jumping jacks, 3 push-ups
4. 4 jumping jacks, 4 push-ups
5. 5 jumping jacks, 5 push-ups
6. 6 jumping jacks, 6 push-ups
7. 7 jumping jacks, 7 push-up
8. 8 jumping jacks, 8 push-ups
9. 9 jumping jacks, 9 push-ups
10. 10 jumping jacks, 10 push-ups
11. Homework —50 knee-ins, 50 sit-up 50 bicycle, 50 reverse curls

In accordance with this invention; a second eating plan following the 14 day cleansing process is provided for muscle strengthening and muscle toning while losing weight and inches of girth around the waist and limbs. Menus representative of the second eating plan for muscle strengthening and muscle toning while losing weight and inches of girth around the waist and limbs process are shown in Tables III and IV.

TABLE III

| | |
|---|---|
| Breakfast | 1 cup fresh strawberries, one half cup Old Fashion |
| | Oatmeal (cook with one half cup non-fat milk, |
| | sprinkle with cinnamon), decaff coffee/tea |
| Snack | One hard boiled egg |
| Lunch | Baked chicken breast, tomato and cucumber salad |
| | With low sugar dressing |
| Snack | 1 small non-fat, sugar free yogurt |
| Supper | Baked fish, green beans, green salad, with low |
| | sugar dressing |

TABLE IV

| | |
|---|---|
| Breakfast | One half grapefruit, 1 slice whole wheat bread, |
| | 1 slice low fat cheese, decaff coffee/tea |
| Snack | 4 oz. non-fat, sugar free yogurt |
| Lunch | Roast beef sandwich (3 oz. lean roast beef, lettuce, |
| | tomato, onion, mustard, 1 slice toasted whole wheat |
| | bread) |
| Snack | 4 oz. non-fat, sugar free yogurt |
| Supper | Baked chicken breast, steamed cabbage, mixed |
| | veggies, dessert of sugar-free gelatin |

In accordance with the current invention; a second exercise regimen, to be worked over the second two (2) week period to provide for maintenance of the individual exerciser's body to the new improved or enhanced level while losing weight and inches of girth around the waist and limbs is provided. The exercise regimen is performed for one hour each of three days each week, preferably Monday, Wednesday and Friday of each week.

The exercise regimen the third week or 7 days is as follows:
Week-3—Monday-Exercises, weights reps are the same as Week-2 Monday; except add another riser whenever the bench is used. Squats done off of the bench for both the inner thigh and the outer thigh while holding the weights in front of the body. Lunges off of the bench we are holding the weights in front of the body.
1. Circuit, Rocket and knee-crunch, Stand feet together, knees slightly bent and abs engaged with arms at sides. Jump up as high as you can using your arms for momentum, and land softly with knees slightly bent, do for one minute. 30 seconds rest
2. Plyometric hop Stand with feet hip distance apart, knees bent and arms at sides with elbows bent. Step out to the right with right foot, straightening right leg. Keep left foot planted and lean slightly. Hop right, landing on right foot, hop to left landing on left foot. Do for 1 minute. 30 seconds rest.
3. Shuffle around the room to right for 30 seconds, shuffle around the room to left for 30 seconds. 30 seconds rest
4. Cool down stretch
5. Home work, 50 reverse curls, 50 full sit-up, 50 knee-ins, bicycle to burn out.
Week-3—Wednesday-Upper Body
1. Push-ups 3 to 4 sets of 12 with 30 second rest between
2. arm circles forward and back 25
3. Repeat 1 & 2
4. Bicep curl using 8 lbs 25 times
5. hammer curls using 8 lbs 25 times
6. Repeat 4 & 5
7. 1 bicep curl 1 hammer curl using 8 lbs dumbbell, 25 times
8. shoulder press, using 8 pounds, 25 times
9. Repeat 4 & 5
10. arm circles no weights 25 forward and 25 back
11. Triceps kickbacks using 8 lbs. 25 times
12. dumb downs, 25 times push your arms out in front palms up, turn palms down as you bring out, then down
13. Shoulder press 8 lbs. 25 times
14. Shoulder circles, 10 times, arm circles 10 times, stretch
15. Bend over Row using 12 lb bar, 3 set of 12
16. upright row using 12 lb bar, 3 sets of 12
17. Military press using 12 bar, 3 sets of 12
18. Side Lateral raises using 5 lbs, 3 sets of 12
19. front Lateral raises using 5 lbs 3 sets of 12
20. Shoulder press using 12 lb. bar 3 sets of 12
21. Flat dumbbell Fly using 2 five pound dumbbell, 3 sets of 12
22. Waist twist, arms over head, no weights, 3 sets of 12
23. Cool down, Stretch
Week-3—Friday—Full Body Sculpt
1. Warm-up and Stretch
2. 7 minute circuit, 1 push-up, 2 lunges 3 calf raises, 5 ballet squats, 7 back lunges, 9 frog jumps 10 mountain climbers, 12 Jacks, 5 cross lunges, 6 ski jumpers, 8 double ski jumpers, 10 running tires 12 deep knee bends, 13 jump shots, 14 v-steps 16 hop Scotch
3. Over head press dumbbells, alternate for 1 minute
4. Over head press single right, 1 minute
5. Over head press single left, 1 minute
6. Squat with double overhead press, 1 minute
7. Triceps curl 10 both arms, 10 alternate, 10 right, 10 left for 1 minute
8. Squat with arm Fly, 1 minute
9. Do the 7 minute Circuit on line 58 60 second rest
10. Front lunges holding 2 8 lb weights, alternate, 1 minute
11. Back lunges holding 2 8 lb weight, alternate, 1 minute
12. Shuffle around room for 1 minute to right, 30 m second rest
13. Shuffle around room for 1 minute to left
14. Cool Down stretch
15. Homework —50 sit-ups, 50 reverse curls, 50 push-ups bicycle to burn out

The exercise regimen the fourth week or 7 days is as follows:
Week-4—Monday-Warm-up stretch
1. Lunges alternating outside, 100, holding two 8 lb. weights
2. Lunges with glute lift, 50, using two 8 lb weights
3. Lunges with knee lift, 50, using two 8 lb weights
4. Abductors, Lying on your right side with hips forward and top leg straight knee slightly bent using one 9 lb bar, lay the bar along the top of the left leg not on the knee. Lift the leg toward the ceiling heel going first. Do 3 sets of 10, pulse for 2 sets of 10
5. Adductor lifts with 9 lb bar, lying on your right side, left foot is on floor behind right leg, place the bar along the right leg and try not to place it on the knee. Again lifting with the heel raise your left leg do not go higher than you right knee. Do 3 sets of 10, pulse 2 sets of 10
6. Back lunges, 3 sets of 12 holding 8 lb. weights in each hand do
7. Front lunges, 3 sets of 12 holding 8 lb. weights in each hand do
8. Squats, using 12 pounds exercise bar on shoulders, 3 sets 10
9. Repeat 7 & 8
10. Squat to right side knee comes up, back lunge on right, do 2 sets of 8
11. Repeat 10 on left side
12. Repeat 10 and 11
13. Cool down and stretch.
Week-4 Wednesday-Upper Body, Warm-up Stretch
1. 7 minute Fat Burn, Squat thrust, 20, push-ups 20, reverse lunge 10 per leg, plank hold 30 seconds, mountain climber, do this with no rest between exercises. Rest 1 minute at the end of 7 minutes.
2. Repeat 1, 3 times
3. Push-up 4 sets with little rest between sets
4. arm circles 20 forward, 20 backward
5. Repeat 1, 3 more times
6. 1 bicep curl, 1 hammer curl, this counts as one, using 8 lb. dumbbell each hand, 3 sets of 10
7. Repeat 4
8. Repeat 6, 20 times
9. Military Press, using 8 lbs dumbbell, do 10 times
10. Repeat 1, 3 times
11. Repeat 3
12. Triceps shoulder combination, kick backs 10 times, 8 lbs.
13. Thumb downs, 10 times, 8 lbs
14. Repeat 12 & 13
15. Repeat 12 & 13
16. up right row, using 12 lb bar do 3 sets of 10
17. Reverse curl, using 12 lb bar, do 3 sets of 10
18. Dead lifts, using 12 lb bar, 3 sets of 10
19. Reverse rows, using 12 lbs, 3 sets 10
20. Cool down, stretch
Week-4—Friday-Full Body Sculpt, repeat Week 3-Friday, 1 through 15

In accordance with this invention; an eating plan following the second two (2) week period of the current invention is provided for metabolic balancing. Menus representative of this third eating plan are shown in Tables V and VI.

TABLE V

| | |
|---|---|
| Breakfast | One half grapefruit or one half cup grapefruit juice, 1 small |
| | veggie omelet, one half cup Old Fashion Oatmeal, decaff |
| | coffee/tea |
| Lunch | Ham or turkey wrap made with romaine lettuce, 1 tbsp low |
| | cal mayonnaise |
| Supper | Grilled chicken (choice of seasoning), 1 or 2 cups steamed |
| | veggies of choice, green salad, dessert of berries of choice |
| | with low cal vanilla yogurt |

TABLE VI

| | |
|---|---|
| Breakfast | 6 oz. veggie juice, one quarter cup Egg Beaters, 1 slice |
| | Canadian bacon, 1 slice whole wheat toast, I tsp sugar-free |
| | fruit spread |
| Lunch | Grilled chicken breast, lettuce and tomato salad with 2 tbsp |
| | low cal dressing, 4 oz. non-fat, sugar free yogurt |
| Supper | Small grilled steak, 1 cup green beans, tomato slices, |
| | steamed broccoli, dessert (1 cup fresh strawberries, 2 tbsp |
| | low-cal whipped cream on top) |

In accordance with the current invention; a third exercise regimen, to be worked over the third two (2) week period to provide for maintenance of the individual exerciser's body to the new improved or enhanced level while losing weight and inches of girth around the waist and limbs is provided. The exercise regimen is performed for one hour each of three days each week, preferably Monday, Wednesday and Friday of each week.

The exercise regimen the fifth week or 7 days is as follows:
Week-5—Monday-Lower Body legs
Repeat Week-4—Monday, 1 through 13
Week-5—Wednesday
1. Warm-up and stretch
2. 1 minute of fast feet (football feet)
3. 10 push-ups
4. Repeat 2 & 3
5. 1 minute jump lunges
6. 1 minute plyo Jacks
7. Repeat 2 & 3
Sitting in chair, weights needed, 5 lbs, 8 lbs, 10 lbs
8. Bicep 10 singles, 3 sets, doubles 2 up 2 down 3 sets 10, right, 5 lbs
9. Repeat 9 on left bicep, with 5 lbs
10. Right arm start with arm close into body, lower bicep for 6 and up for one, do this 3 sets of 10, 8 lbs
11. Repeat 10, on left bicep
12. Repeat 9 through 12
13. Right over head triceps curls, using 8 lbs 3 sets of 10
14. Repeat 13 on left triceps
15. Right over head triceps curls using 8 lbs, 3 sets of 10 lower down for 3 and up on one
16. Repeat 15 on left triceps
17. Repeat 13, 14 and 15, 16, 3 sets of 10
18. Standing, using 101 bs dumbbells, do bend over rows, both hands do 3 sets of 10
19. Bend over rows single on right 3 sets of 10
20. Repeat 19 on left, 3 sets of 10
21. Repeat 18 & 19
22. Dead lift using 2 10 lbs dumbbells, 3 sets of 10
23. Up right row, using 10 lbs dumbbells, 3 sets of 10
24. Cool Dow and stretch
Week-5—Friday-Repeat Week-3—Friday, 1 through 14

The exercise regimen the sixth week or 7 days is as follows:
Week-6—Monday-Lower body, Repeat Week-4—Monday, 1 through 13, repeat Week-2—Friday, 1 through 10
Week-6—Wednesday-Arms and upper body, repeat Week-5—Wednesday, 1 through 24, repeat Week-2—Friday, 1 through 10
Week-6—Friday-Repeat Week-3—Friday, Full body sculpt, 1 through 14, repeat Week-2—Friday, 1 through 10

In accordance with the current invention measurable results in terms of reduced inches, pounds and BMI are determined and tabulated from measurements taken before and after execution of the method of the current invention.

### BRIEF DESCRIPTION OF DRAWINGS

The above and other advantages of the current invention will become more apparent from the following description taken in conjunction with the accompanying drawings, in which:

FIG. 1 is a representation of the prior art process stressing body shape and diet as most important to weight loss and physical fitness according to the teaching of Cabot, “The Body Shaping Diet”, SCB International, 2000.

FIG. 2 is a representation of the prior art stressing body shape and exercise as most important to weight loss and physical fitness according to the teaching of Jackowski, U.S. Pat. No. 6,945,911, Jackowski, Sep. 20, 2005.

FIG. 3 is a representation of the method and process of the current invention which provides a balanced fitness method providing for the “jump starting” of body metabolism from an anabolic state to a catabolic or fat burning state; restores the anabolic/catabolic balance and is designed to work in concert with specific exercise regimens to achieve, balanced fitness method which provides for the “jump starting” of body metabolism from an anabolic state to a catabolic or fat burning state; restores the anabolic/catabolic balance and is designed to work in concert with specific exercise regimens to achieve, in a short span of time, quantifiable fitness results in pounds, inches, and indices; regardless of body type in pounds, inches, and indices; regardless of body type.

FIG. 4 is a graphical representation representing the effectiveness of the current invention balanced fitness method which provides, in a short span of time, quantifiable fitness results.

### DETAILED DESCRIPTION OF THE INVENTION

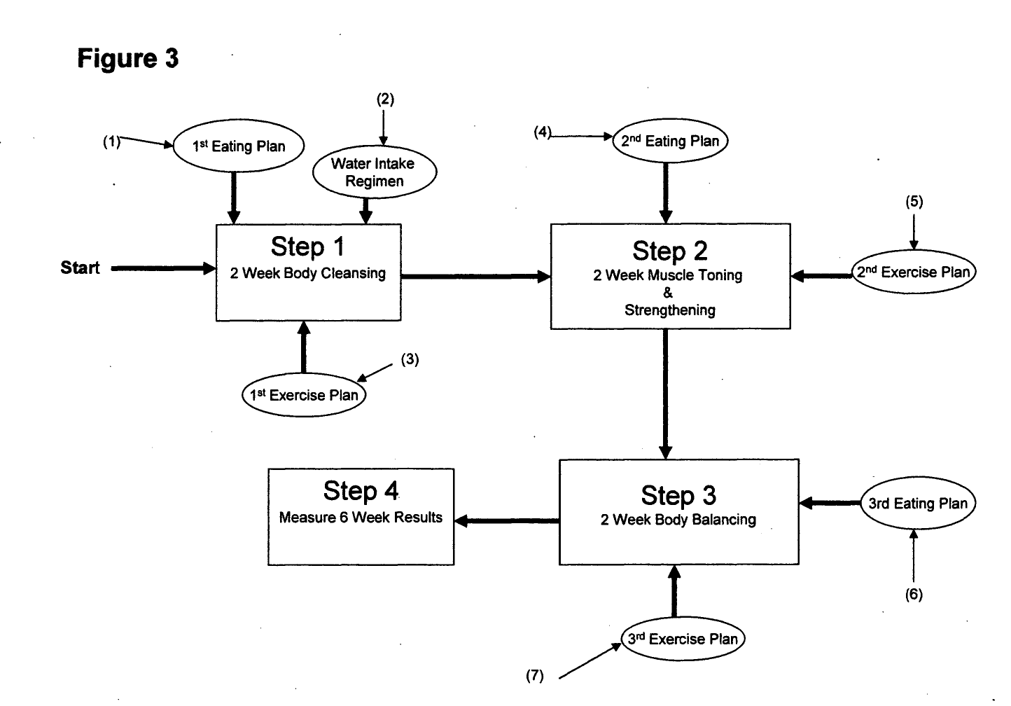

A method is provided for producing substantial weight loss and reduced inches in girth measurements for exercisers' calves, thighs, hips, waists, abdomens, arms and busts. The method is comprised of three steps of two (2) weeks duration as shown in FIG. 3. Step 1 accomplishes body cleansing. Step 2 accomplishes muscle toning and strengthening. The final step, Step 3, accomplishes body balancing.

Step 1 is further comprised of a 1^{st} Eating Plan (1), a Water Intake Regimen (2) and a 1^{st} Exercise Plan (3). Step 2 is further comprised of a 2^{nd} Eating Plan (4) and a 2^{nd} Exercise Plan (5). Step 3 is further comprised of a 3^{rd} Eating Plan (6) and a 3^{rd} Exercise Plan (7). Exercise Plans (3), (5) and (7) are executed 3 days per week for 1 hour and are in addition to individual exerciser's existing exercise regimen.

The 1^{st} Eating Plan (1) is formulated to “jump start” the body metabolisms of exercisers from an anabolic state, which builds up and stores fat tissue work, to a catabolic state which breaks down the fat tissue to generate fuel to perform body functions. 1^{st} Eating Plan (1) works with Water Intake Regimen (2) and 1^{st} Exercise Plan (3) to rapidly burn stored body fat and flush the byproducts from body cells. Aforementioned Tables I and II are representative menus of 1^{st} Eating Plan (1). Water Intake Regimen (2) requires the drinking of at least one (1) ten ounce glass of water an hour during the exerciser's awake hours. The 1^{st} Exercise Plan (3) is comprised of Week 1 and Week 2 exercises as described above.

The 2^{nd} Eating Plan (4) is formulated to promote the continued burning of stored fat while building and strengthening muscle tissue when worked in concert with 2^{nd} Exercise Plan (5). Aforementioned Tables III and IV are representative menus of the 2^{nd} Eating Plan (4). The 2^{nd} Exercise Plan (5) is comprised of Week 3 and Week 4 exercises as described above.

The 3^{rd} Eating Plan (6) is formulated to bring the body metabolism to an anabolic/catabolic balance when worked in concert with 3^{rd} Exercise Plan (7) and maintain the bodies of exercisers' to their new improved level of fitness. Aforementioned Tables V and VI are representative menus of 3^{rd} Eating Plan (6). The 3^{rd} Exercise Plan (7) is comprised of Week 5 and Week 6 exercises as described above.

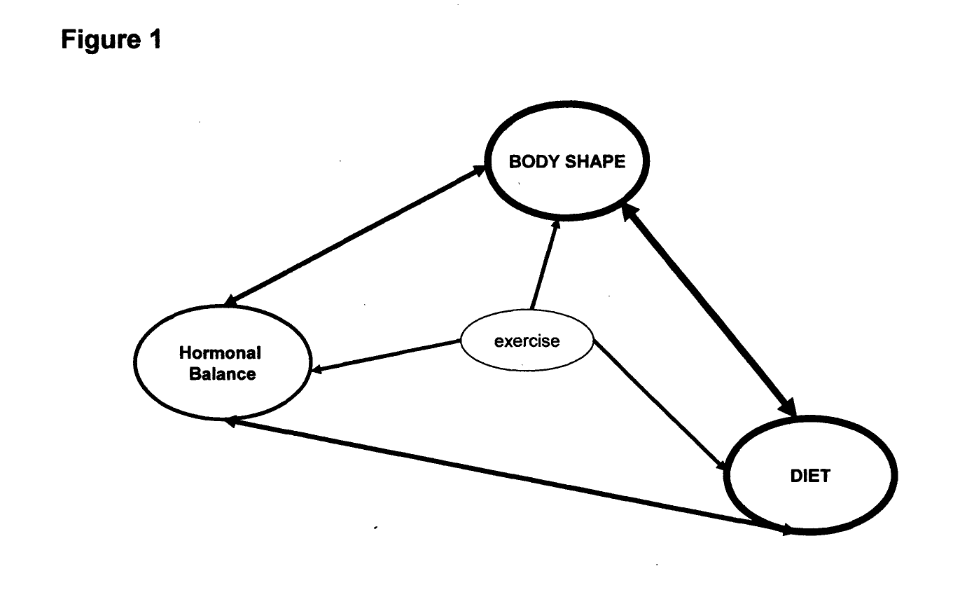

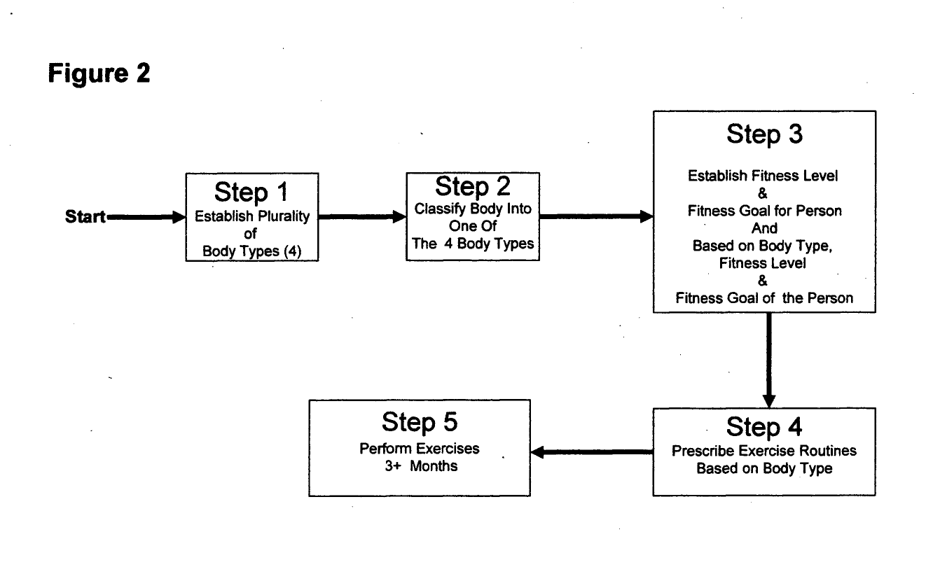

In contrast to the prior art depicted in FIGS. 1 and 2; the current invention is not based on body type but is applicable to all body types. Exercisers who followed the method of the current invention as detailed above; exhibited reductions in inches of girth, and body weight as shown in Tables VII, through X11 below:

TABLE VII

| Exerciser 1 | Before | After | Reduction | % Reduction |
|---|---|---|---|---|
| R Arm | 11.50 | 10.25 | 1.25 | 11 |
| L Arm | 11.00 | 10.00 | 1.00 | 9 |
| Bust | 36.50 | 34.00 | 2.50 | 7 |
| Abdomen | 35.00 | 28.00 | 7.00 | 20 |
| Waist | 30.00 | 27.00 | 3.00 | 10 |
| Hips | 39.50 | 36.00 | 3.50 | 9 |
| Thighs | 21.00 | 19.25 | 1.75 | 8 |
| Calf | 15.00 | 15.00 | 0.00 | 0 |
| | Total Inches Reduced | | 20.00 | |
| Wt. in lbs. | 138.00 | 122.00 | 16.00 | 12 |
| BMI | 26.00 | 22.30 | 3.70 | 14 |

TABLE VIII

| Exerciser 2 | Before | After | Reduction | % Reduction |
|---|---|---|---|---|
| R Arm | 11.50 | 11.50 | 0.00 | 0 |
| L Arm | 12.00 | 12.00 | 0.00 | 0 |
| Bust | 39.00 | 38.75 | 0.25 | 1 |
| Abdomen | 40.50 | 36.50 | 4.00 | 10 |
| Waist | 32.00 | 31.50 | 0.50 | 2 |
| Hips | 41.00 | 40.25 | 0.75 | 2 |
| Thighs | 20.00 | 19.75 | 0.25 | 1 |
| Calf | 14.25 | 14.00 | 0.25 | 2 |
| | Total Inches Reduced | | 6.00 | |
| Wt. in lbs. | 157.50 | 145.00 | 12.50 | 8 |
| BMI | 26.12 | 24.90 | 1.22 | 5 |

TABLE IX

| Exerciser 3 | Before | After | Reduction | % Reduction |
|---|---|---|---|---|
| R Arm | 11.50 | 10.25 | 1.25 | 11 |
| L Arm | 11.00 | 10.25 | 0.75 | 7 |
| Bust | 36.00 | 32.25 | 3.75 | 10 |
| Abdomen | 37.00 | 31.00 | 6.00 | 16 |
| Waist | 33.00 | 27.00 | 6.00 | 18 |
| Hips | 41.25 | 38.00 | 3.25 | 8 |
| Thighs | 20.00 | 21.00 | −1.00 | −5 |
| Calf | 14.50 | 14.25 | 0.25 | 2 |
| | Total Inches Reduced | | 20.25 | |
| Wt. in lbs. | 152.50 | 135.00 | 17.50 | 11 |
| BMI | 23.80 | 21.1 | 2.70 | 11 |

TABLE X

| Exerciser 4 | Before | After | Reduction | % Reduction |
|---|---|---|---|---|
| R Arm | 11.60 | 11.30 | 0.30 | 2 |
| L Arm | 11.80 | 11.00 | 0.80 | 6 |
| Bust | 49.00 | 46.00 | 3.00 | 6 |
| Abdomen | 45.00 | 43.00 | 2.00 | 4 |
| Waist | 42.00 | 39.30 | 2.80 | 7 |
| Hips | 44.00 | 42.50 | 1.50 | 3 |
| Thighs | 20.50 | 19.00 | 1.50 | 7 |
| Calf | 11.80 | 11.80 | 0.00 | 0 |
| | Total Inches Reduced | | 11.80 | |
| Wt. in lbs. | 193.00 | 177.00 | 16.00 | 8 |
| BMI | 27.80 | 26.80 | 1.00 | 4 |

TABLE XI

| Exerciser 5 | Before | After | Reduction | % Reduction |
|---|---|---|---|---|
| R Arm | 14.50 | 13.00 | 1.50 | 10 |
| L Arm | 14.50 | 14.00 | 0.50 | 3 |
| Bust | 42.50 | 37.00 | 5.50 | 13 |
| Abdomen | 41.25 | 38.25 | 3.00 | 7 |
| Waist | 35.00 | 32.00 | 3.00 | 9 |
| Hips | 45.50 | 44.00 | 1.50 | 3 |
| Thighs | 24.50 | 22.00 | 2.50 | 10 |
| Calf | 15.00 | 14.00 | 1.00 | 7 |
| | Total Inches Reduced | | 18.50 | |
| Wt. in lbs. | 186.50 | 169.00 | 17.50 | 9 |
| BMI | 30.00 | 26.9 | 3.10 | 10 |

TABLE XII

| Exerciser 6 | Before | After | Reduction | % Reduction |
|---|---|---|---|---|
| R Arm | 9.50 | 10.00 | −0.50 | −5 |
| L Arm | 9.75 | 10.00 | −0.25 | −3 |
| Bust | 33.75 | 33.25 | 0.50 | 1 |
| Abdomen | 33.00 | 29.00 | 4.00 | 12 |
| Waist | 25.50 | 26.00 | −0.50 | −2 |
| Hips | 38.00 | 37.50 | 0.50 | 1 |
| Thighs | 18.00 | 17.00 | 1.00 | 6 |
| Calf | 12.25 | 11.00 | 1.25 | 10 |
| | Total Inches Reduced | | 6.00 | |
| Wt. in lbs. | 124.50 | 122.00 | 2.50 | 2 |
| BMI | 22.10 | 21.50 | 0.60 | 3 |

Exercisers 1, 2, and 3 of Tables VII, VIII and IX regularly exercised three (3) times each week. The exercise plans of the current invention were performed in addition to their regular exercise regimen. In addition each of the three exercisers had exhibited a “plateau” effect where continued performance of their regular regimen had ceased to provide reduction of body part girth and/or weight loss.

Exercisers 4, 5, and 6 of Tables X, XI and XII were beginning exercisers who had not plateaued. The exercise plans of the current invention were performed in addition to their regular exercise regimen.

Immediately prior to beginning the execution of the method of the current invention, each exerciser was measured for inches of girth around both arms, bust abdomen, waist, hips, thighs, and calves. In addition each exerciser was weighed. The weight, height, age, gender and whether or not the exerciser was athletic was input into a Model HBF-306 BL Omron Body Fat Analyzer manufactured by Country Technology, Inc., P.O. Box 87, Gay Mills, WI 54631. The Omron Body Fat Analyzer automatically calculated the BMI for each exerciser.

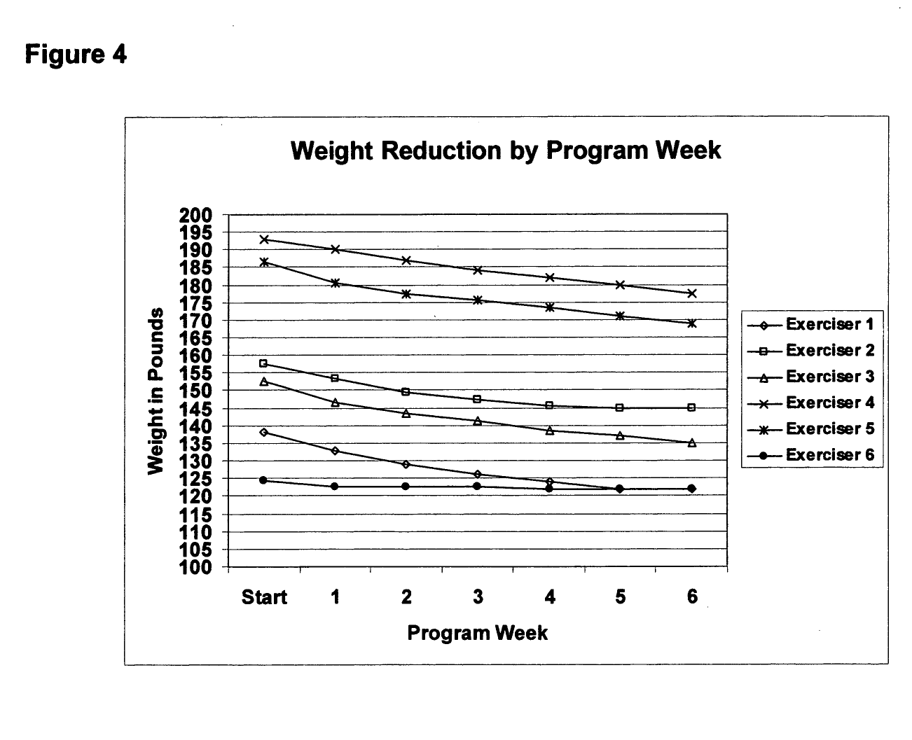

Each of the six (6) exercisers were again weighed after completing each week of the method of the current invention and weight loss monitored as shown in FIG. 4.

Immediately following completion of the entire six (6) weeks of the method of the current invention, each exerciser was again measured, weighed and their BMI calculated by Model HBF-306 BL Omron Body Fat Analyzer. The difference in inches of girth, weight, and BMI for each exerciser are shown in Tables VII, through XII.

Further the current invention of FIG. 3 in contrast to the prior art of FIGS. 1 & 2; produces measurable results as early as one (1) week into the method, as shown in FIG. 4; with substantial reductions after six (6) weeks for inches of girth, weight, and BMI as shown in aforementioned Tables VII, through XII. The prior art is ambiguous in terms of results; mentioning a time span of greater than three (3) months or greater than twelve (12) weeks. Therefore; the method of the current invention is a significant improvement over the prior art, having provided a six (6) week method to provide for significant weight loss accompanied by reductions in girth for the bust (women), waist, abdomen, hips, thighs, calves, and arms. In addition the method of the current invention, over and above the prior art, provides for an improved level of fitness and reduced health risks as evidenced by lower BMI.

It will be obvious to one skilled in the art that numerous modifications and variations of the current invention as described above are possible. Therefore; it is to be understood that the invention may be practiced other than specifically described above.

1. A method for increasing body fitness level and reducing health risks while losing body weight, said method comprising the steps of:
a. Two (2) week body cleansing
b. Two (2) week muscle toning and strengthening
c. Two (2) week body balancing

2. A method as recited in claim 1 wherein the two (2) week cleansing step is comprised of a 1^{st} eating plan, a water intake regimen and a 1^{st} exercise plan.

3. A method as recited in claim 1 wherein the two (2) week muscle toning and strengthening step is comprised of a 2^{nd} eating plan and a 2^{nd} exercise plan.

4. A method of claim 1 where in the two (2) week body balancing step is comprised of a 3^{rd} eating plan and a 3^{rd} exercise plan.

5. A method as recited in claim 2 wherein the 1^{st} eating plan is comprised of meals of which Tables I and II above are representative.

6. A method as recited in claim 2 wherein the 1^{st} exercise plan is comprised of exercises Week 1 and Week 2 defined herein.

7. A method as recited in claim 3 wherein the 2^{nd} eating plan is comprised of meals of which Tables III and IV above are representative.

8. A method as recited in claim 3 wherein the 2^{nd} exercise plan is comprised of exercises Week 2 and Week 3 defined herein.

9. A method as recited in claim 4 wherein the 3^{rd} eating plan is comprised of meals of which Tables V and VI above are representative.

10. A method as recited in claim 4 wherein the 3^{rd} eating plan is comprised of exercises Week 5 and Week 6 defined herein

11. A method as recited in claim 1 wherein measurable reductions in body weight and inches of body part girth are obtained as represented in Tables VII through XII.

12. A method as recited in claim 1 wherein measurable reductions in BMI are obtained as represented in Tables VII through XII.

13. A method as recited in claim 11 wherein measurable reductions in body weight and inches of body part girth are obtained in six (6) weeks as represented in FIG. 4.

14. A method as recited in claim 11 wherein measurable reductions in BMI are obtained in six (6) weeks as represented in Tables VII through XII.

15. A method as recited in claim 11 wherein measurable reductions in body weight and inches of body part girth are obtained regardless of body type.

16. A method as recited in claim 11 wherein measurable reductions BMI are obtained regardless of body type.
